(19) United States
(12) Patent Application Publication
(10) Pub. No.: US 2025/0090949 A1
(43) Pub. Date: Mar. 20, 2025

(54) NON-TRANSITORY COMPUTER READABLE MEDIUM, INFORMATION PROCESSING METHOD, AND INFORMATION PROCESSING SYSTEM

(71) Applicant: CYGAMES, INC., Tokyo (JP)

(72) Inventors: Hiroki Matsuura, Tokyo (JP); Makoto Hirata, Tokyo (JP); Kengo Shibata, Fukuoka (JP); Kensuke Nishida, Fukuoka (JP); Ryosuke Nakahara, Fukuoka (JP)

(73) Assignee: CYGAMES, INC., Tokyo (JP)

(21) Appl. No.: 18/970,143

(22) Filed: Dec. 5, 2024

Related U.S. Application Data
(63) Continuation of application No. PCT/JP2023/018996, filed on May 22, 2023.

(30) Foreign Application Priority Data
Jun. 8, 2022 (JP) 2022-093061

(51) Int. Cl. A63F 13/422; A63F 13/52; A63F 13/58

(52) U.S. Cl. CPC A63F 13/422; A63F 13/52; A63F 13/58

(57) ABSTRACT

A non-transitory computer readable medium stores a program instructing a computer to execute a process of setting, on a basis of a setting operation of a player, a plurality of sub objects to be displayed in a game screen along with a main object, a process of carrying out, on a basis of an attack operation of the player, attack motions respectively specified for the plurality of sub objects displayed in the game screen, the attack motions being carried out in a preset order, a process of updating display information corresponding to display appearances of the sub objects when a particular condition is satisfied, and a process of displaying, in the game screen, the sub objects in the display appearances based on the display information.

### CROSS REFERENCE TO RELATED APPLICATIONS

This application is a continuation application of International Application No. PCT/JP2023/018996, filed on May 22, 2023, which claims priority to Japanese Patent Application No. 2022-093061, filed on Jun. 8, 2022, the entire contents of which are incorporated by reference herein.

### BACKGROUND ART

### Technical Field

The present invention relates to an information processing program, an information processing method, and an information processing system.

Action games in which characters carry out attack motions as players input attack operations are known. For example, Patent Literature 1 discloses a game in which combination attacks occur when attack operations are continuously input within a particular period of time. According to this game, different combination attacks occur depending on the pattern of the attack operations that are input.

### CITATION LIST

### Patent Literature

Patent Literature 1: JP 6902461 B

### SUMMARY OF INVENTION

### Technical Problem

Action games in which the player can select objects such as characters to be operated by the player and equipment of the characters are known. An issue to be addressed is that when the player selects the same objects every time the player plays the game, the display appearance of the game screen remains unchanged, and the player is less motivated to play the game.

The present invention aims to provide an information processing program, an information processing method, and an information processing system that can improve the player's motivation to play the game.

### Solution to Problem

To resolve the aforementioned problems, an information processing program instructs a computer to execute:
a process of setting, on a basis of a setting operation of a player, a plurality of sub objects to be displayed in a game screen along with a main object;
a process of carrying out, on a basis of an attack operation of the player, attack motions respectively specified for the plurality of sub objects displayed in the game screen, the attack motions being carried out in a preset order;
a process of updating display information corresponding to display appearances of the sub objects when a particular condition is satisfied; and
a process of displaying, in the game screen, the sub objects in the display appearances based on the display information.

The process of carrying out the attack motions may involve:
carrying out the attack motions in the preset order when, after one of the attack operation is input, the next attack operation is input within a particular time.

In addition, the setting operation may include an automatic setting operation, and
the process of setting the sub objects may involve:
   selecting and setting a plurality of the sub objects according to a particular algorithm on the basis of an input of the automatic setting operation.

To resolve the aforementioned problems, an information processing method may be executed by at least one computer,
wherein the computer executes:
a process of setting, on a basis of a setting operation of a player, a plurality of sub objects to be displayed in a game screen along with a main object;
a process of carrying out, on a basis of an attack operation of the player, attack motions respectively specified for the plurality of sub objects displayed in the game screen, the attack motions being carried out in a preset order;
a process of updating display information corresponding to display appearances of the sub objects when a particular condition is satisfied; and
a process of displaying, in the game screen, the sub objects in the display appearances based on the display information.

To resolve the aforementioned problems, an information processing system includes at least one computer,
wherein the computer executes:
a process of setting, on a basis of a setting operation of a player, a plurality of sub objects to be displayed in a game screen along with a main object;
a process of carrying out, on a basis of an attack operation of the player, attack motions respectively specified for the plurality of sub objects displayed in the game screen, the attack motions being carried out in a preset order;
a process of updating display information corresponding to display appearances of the sub objects when a particular condition is satisfied; and
a process of displaying, in the game screen, the sub objects in the display appearances based on the display information.

### Effects of Disclosure

According to the present invention, the player's motivation to play the game can be improved.

### BRIEF DESCRIPTION OF DRAWINGS

FIG. 1 is a diagram illustrating a schematic configuration of an information processing system.

FIG. 2A is a diagram illustrating a hardware configuration of a player terminal. FIG. 2B is a diagram illustrating a hardware configuration of a server.

FIG. 3 is a diagram illustrating one example of an analog controller.

FIG. 4 is a diagram illustrating one example of a game screen.

FIG. 5A is a first diagram illustrating an attack motion of a sub character. FIG. 5B is a second diagram illustrating an attack motion of a sub character.

FIG. 6A is a third diagram illustrating an attack motion of a sub character. FIG. 6B is a fourth diagram illustrating an attack motion of a sub character.

FIG. 7A is a diagram illustrating a game screen that appears when a boss stage is cleared, and FIG. 7B is a diagram illustrating a game screen that appears when a sub character candidate is acquired.

FIG. 8 is a table of sub characters.

FIG. 9A is a first diagram illustrating an organization screen. FIG. 9B is a second diagram illustrating the organization screen.

FIG. 10 is a table of first setting information.

FIG. 11 is a table of combination setting information.

FIG. 12A is a first diagram illustrating an example of a sub character candidate selection process executed by an automatic organization function. FIG. 12B is a second diagram illustrating the example of the sub character candidate selection process executed by the automatic organization function. FIG. 12C is a third diagram illustrating the example of the sub character candidate selection process executed by the automatic organization function.

FIG. 13A is a fourth diagram illustrating the example of the sub character candidate selection process executed by the automatic organization function. FIG. 13B is a fifth diagram illustrating the example of the sub character candidate selection process executed by the automatic organization function. FIG. 13C is a sixth diagram illustrating the example of the sub character candidate selection process executed by the automatic organization function.

FIG. 14 is a diagram illustrating a configuration of a memory in a player terminal and the function thereof as a computer.

FIG. 15 is a flowchart indicating a preparation process.

FIG. 16 is a flowchart indicating an automatic organization process.

FIG. 17 is a flowchart indicating an in-game process.

FIG. 18 is a flowchart indicating an operation input process.

FIG. 19 is a flowchart indicating an enemy character control process.

FIG. 20 is a flowchart indicating a hit judgement process.

### DESCRIPTION OF EMBODIMENTS

One aspect of embodiments of the present invention will now be described in detail by referring to the attached drawings. Numerical figures, etc., indicated in the embodiments are merely examples provided to promote understanding, and do not limit the present invention unless otherwise noted. Note that, in the present description and the drawings, the elements having the substantially same functions and configurations are denoted by the same reference signs to omit redundant descriptions, and the elements not directly related to the present invention are not illustrated.

### Overall Configuration of Information Processing System S

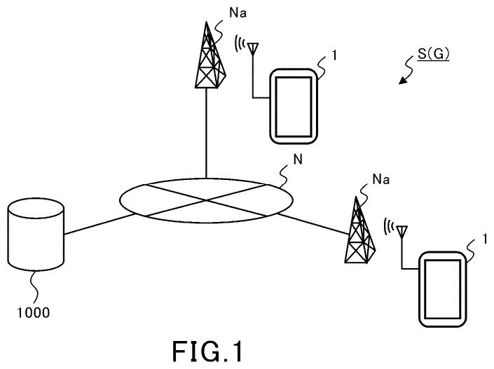

FIG. 1 is a diagram illustrating a schematic configuration of an information processing system S. The information processing system S is a so-called client-server system that includes player terminals 1 that function as clients, that is, game terminals, a server 1000, and a communication network N having communication base stations Na.

In the information processing system S of this embodiment, the player terminals 1 function as game devices G. The player terminal 1, for example, acquires from the server 1000 and keeps programs etc., necessary to play the game. Alternatively, each of the player terminals 1 and the server 1000 may be assigned with a role in controlling the progress of the game so that the game can proceed by collaboration of the player terminals 1 and the server 1000. In this case, the player terminals 1 and the server 1000 function as the game devices G.

The player terminals 1 can establish communication with the server 1000 through the communication network N. The player terminals 1 widely include electronic appliances that can communicatively connect to the server 1000 with or without wires. Examples of the player terminals 1 include smart phones, cellular phones, tablet devices, personal computers, and dedicated game consoles. In this embodiment, an example in which dedicated game consoles are used as the player terminals 1 is described.

The server 1000 is communicatively connected to multiple player terminals 1. The server 1000 accumulates various pieces of information for each of the players playing the game. In addition, the server 1000 executes processes such as updating the accumulated information and downloading images and various pieces of information onto the player terminals 1 on the basis of operations input through the player terminals 1.

The communication base stations Na are connected to the communication network N and wirelessly exchange information with the player terminals 1. The communication network N is constituted by the cellular phone network, the internet network, a local area network (LAN), a dedicated line, etc., and realizes wireless or wired communication connection between the player terminals 1 and the server 1000.

### Hardware Configurations of Player Terminals 1 and Server 1000

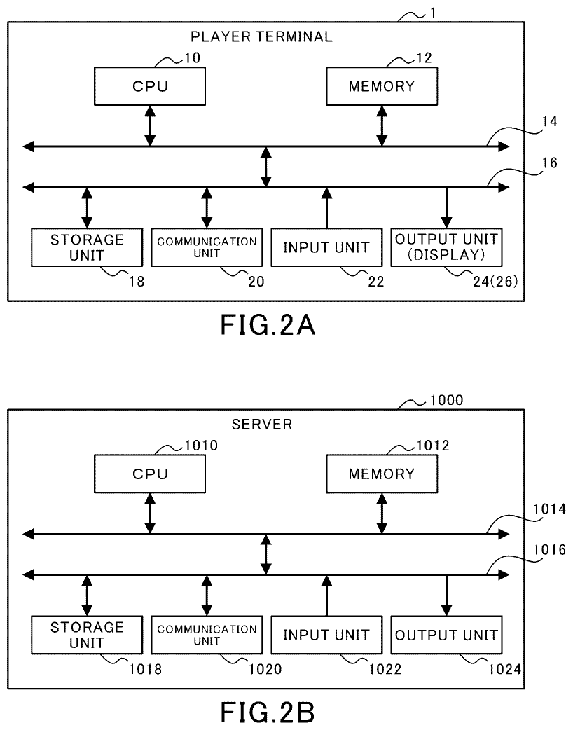

FIG. 2A is a diagram illustrating the hardware configuration of the player terminal 1. FIG. 2B is a diagram illustrating the hardware configuration of the server 1000. As illustrated in FIG. 2A, the player terminal 1 includes a central processing unit (CPU) 10, a memory 12, a bus 14, an I/O interface 16, a storage unit 18, a communication unit 20, an input unit 22, and an output unit 24.

As illustrated in FIG. 2B, the server 1000 includes a CPU 1010, a memory 1012, a bus 1014, an I/O interface 1016, a storage unit 1018, a communication unit 1020, an input unit 1022, and an output unit 1024.

The configurations and functions of the CPU 1010, the memory 1012, the bus 1014, the I/O interface 1016, the storage unit 1018, the communication unit 1020, the input unit 1022, and the output unit 1024 of the server 1000 are substantially the same as those of the CPU 10, the memory 12, the bus 14, the I/O interface 16, the storage unit 18, the communication unit 20, the input unit 22, and the output unit 24 of the player terminal 1, respectively. Thus, in the description below, the hardware configuration of the player terminal 1 is described, and the description of the server 1000 is omitted.

The CPU 10 runs the programs stored in the memory 12 and controls the progress of the game. The memory 12 is constituted by a read-only memory (ROM) or a random access memory (RAM) and stores programs and various pieces of data necessary to control the progress of the game. The memory 12 is connected to the CPU 10 via the bus 14.

The I/O interface 16 is connected to the bus 14. The storage unit 18, the communication unit 20, the input unit 22, and the output unit 24 are connected to the I/O interface 16.

The storage unit 18 is constituted by a semiconductor memory such as a dynamic random access memory (DRAM) and stores various programs and data. In the player terminal 1, the CPU 10 loads the programs and data stored in the storage unit 18 onto the memory 12 (RAM).

The communication unit 20 is communicatively connected to the communication base station Na wirelessly, and exchanges information, such as various pieces of data and programs, with the server 1000 via the communication network N. The player terminal 1 receives programs etc., from the server 1000 and stores them in the memory 12 or the storage unit 18.

The input unit 22 is constituted by, for example, a touch panel, buttons, a keyboard, a mouse, arrow keys, or an analog controller through which the operation of the player is input (the operation is accepted). Alternatively, the input unit 22 may be a dedicated controller installed in the player terminal 1 or connected (externally attached) to the player terminal 1. Furthermore, the input unit 22 may be constituted by an acceleration sensor that detects tilts and movements of the player terminal 1 or a microphone that detects the voice of the player. In other words, the input unit 22 may include a wide variety of devices through which the intention of the player can be input in a recognizable manner.

The output unit 24 includes a display device and a speaker. Alternatively, the output unit 24 may be an appliance connected (externally attached) to the player terminal 1. In this embodiment, the player terminal 1 is equipped with a display 26 as the output unit 24 and an analog controller 30 connected to the player terminal 1 as the input unit 22.

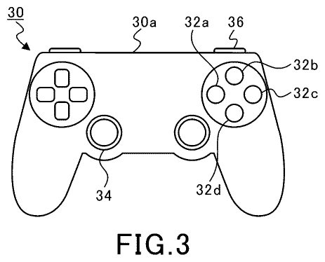

FIG. 3 is a diagram illustrating one example of the analog controller 30. The analog controller 30 has a controller body 30a. The controller body 30a is shaped so that the player can grasp it with two hands. In the controller body 30a, a left button 32a, an up button 32b, a right button 32c, and a down button 32d are provided. The left button 32a, the up button 32b, the right button 32c, and the down button 32d are positioned so that the player grasping the controller body 30a can press these buttons with the player's right thumb.

In addition, the controller body 30a is equipped with a tilt operation unit 34. The tilt operation unit 34 is a so-called analog stick, protrudes from the body 30a, and can be tilted in all directions 360°. The tilt operation unit 34 is positioned so that the player grasping the controller body 30a can conduct a tilt operation with the player's left thumb.

Furthermore, the controller body 30a is also equipped with a side button 36. The side button 36 is positioned so that the player grasping the controller body 30a can press the button with the player's right index finger. Although the controller body 30a is further equipped with other operation units, the description therefor is omitted here.

### Game Contents

Next, the game provided by the information processing system S and the game devices G of this embodiment is described. In this embodiment, an action role playing game is provided. The player operates the main character and plays the game to clear multiple stages one by one.

In this embodiment, there are, for example, fifty stages from phase 1 to phase 50. The player must clear each stage one by one from phase 1. The player can play a next-phase stage by clearing the stage of a preceding phase.

In this embodiment, there are a phase in which one type of stages are provided and a phase in which multiple types of stages are provided. In the phase in which only one type of stages are provided, the player needs to always clear the same stage. In contrast, in the phase where multiple types of stages are provided, the stage to be played by the player is determined by a lottery. The multiple types of stages set for the same phase differ from one another in the fields where the main character can move about, the enemy characters that emerge, etc.

Here, the stages are roughly divided into normal stages and boss stages. In a normal stage, an enemy character is assigned. The player needs to have the player's main character reach the goal set for each normal stage by taking down the enemy character. When the main character reaches the goal, the stage is cleared, and the player can play a stage of the next phase.

A boss stage is set to emerge every five phases, for example. In addition, there is only one type of the boss stage set for one phase in this embodiment. In a boss stage, a boss character is assigned as an enemy character. A boss character is set to be stronger than the enemy characters assigned in the normal stages. The boss stage is cleared when the boss character is taken down.

Although both normal stages and boss stages are provided here, only one may be provided alternatively. In addition, although a phase in which one stage is selected from multiple stages by a lottery is provided here, alternatively, only one stage may always be provided for one phase.

In each stage, the player can acquire rewards such as items. Moreover, the player can acquire experience points by taking down the enemy character or clearing the stage. The level of the main character rises by acquiring the experience points. Various parameters, in other words, strength values, of the main character increase as the level rises. Note here that the acquisition of the experience points is not the only way to raise the level. For example, the level may rise by acquiring items in the stages. Furthermore, the level may rise by acquiring both the experience points and the items. Examples of the parameters set for the main character include hit points (HP), attack power, and defense power. The strength value of the main character is calculated by using these parameters.

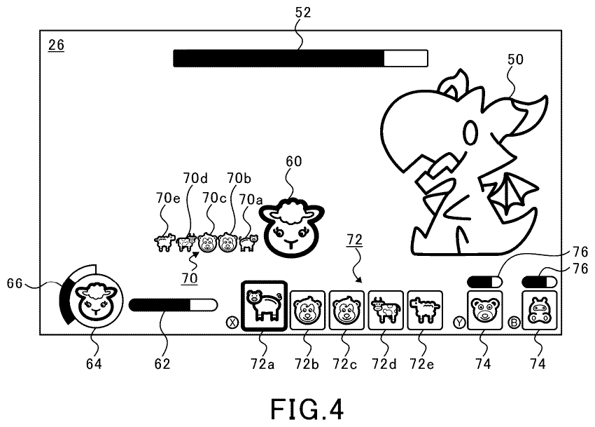

FIG. 4 is a diagram illustrating one example of a game screen. FIG. 4 illustrates a game screen of a boss stage. In the boss stage, a boss character 50 is displayed in a 2D game screen. The boss character 50 differs for each boss stage. The movements of the boss character 50 are computer-controlled. Furthermore, a HP is set as a parameter for the boss character 50. A boss character HP bar 52 is displayed in the upper portion of the game screen. The boss character HP bar 52 visually indicates the proportion of the current remaining HP with respect to the maximum value of the HP of the boss character 50.

In each stage, the main character 60 is displayed in the game screen. As described above, the main character 60 is a character to be operated by the player. The player can make the main character 60 carry out various motions by inputting operations to the analog controller 30. A HP is set as a parameter for the main character 60. A main character HP bar 62 is displayed in the lower left portion of the game screen. The main character HP bar 62 visually indicates the proportion of the current remaining HP with respect to the maximum value of the HP of the main character 60. Although the detailed description is omitted, the maximum value of the HP rises as the level of the main character 60 rises.

In this embodiment, one character that can be set as the main character 60 is provided. Thus, the main character 60 to be operated by the player is always the same. Alternatively, the player may be able to select one character out of multiple main character candidates and set the selected character as the main character 60. On the left side of the main character HP bar 62, a main character icon 64 corresponding to the main character 60 and a fever gauge 66 are displayed.

The fever gauge 66 visually indicates the proportion of the current value of fever points with respect to the maximum value of the fever points. The fever point is a parameter set for the main character 60 and rises when a particular condition is satisfied. Here, to inflict damage on the boss character 50 is set as the particular condition. The fever point is given according to the damage inflicted on the boss character 50, in other words, the decrease in HP of the boss character 50.

The particular condition that raises the fever point is not limited to this. For example, the fever point may rise each time a particular time period elapses. Alternatively, for example, the particular condition for raising the fever point may be that the main character 60 is damaged, that an enemy character other than the boss character 50 is damaged, that a particular enemy character including the boss character 50 is taken down, that an item is used, etc.

Once the fever point reaches the maximum value, a fever stock is given, and the fever point is reset to an initial value. The main character 60 can retain up to two fever stocks simultaneously. For example, suppose that there is zero fever stock and the fever point has reached the maximum value. In such a case, one fever stock is given and the fever point is reset to the initial value simultaneously. Subsequently, when the fever point reaches the maximum value again, a second fever stock is given, and the fever point is reset to the initial value. In a state where two fever stocks are retained, the fever point is no longer given. In other words, the particular condition for raising the fever point includes that the main character 60 retains less than two fever stocks.

In addition, when a particular activation operation is input in the state where one or two fever stocks are retained, one fever stock is consumed and a fever mode starts. During the fever mode, the main character 60 transforms into a special character. In the state where the main character 60 has transformed into a special character, the main character 60 can no longer be damaged by the enemy character, and the HP of the main character 60 does not decrease. Moreover, an attack motion is set for the special character, and when an attack operation is input, a particular attack motion is carried out. By carrying out the attack motion, damage can be inflicted on the boss character 50.

Here, during the fever mode, an image corresponding to the special character may be displayed in the main character icon 64. In addition, an ending condition is set for the fever mode. When the ending condition is satisfied, the fever mode comes to an end, and the special character returns to the main character 60. Here, the elapse of a preset duration period is set as the ending condition, and the fever mode ends as the duration period elapses.

Furthermore, sub characters 70 are displayed in the game screen. The sub characters 70 are displayed in the game screen along with the main character 60. For example, when the main character 60 moves, the sub characters 70 also move as if to chase the main character 70. There are multiple types of characters that can be set as the sub characters 70, that is, sub character candidates.

The player can retain sub character candidates by clearing a particular stage. Alternatively, for example, the player may be able to retain sub character candidates while playing a particular stage. Yet alternatively, the player may be able to purchase sub character candidates by consuming in-game currency or items. The player can set up to five sub characters 70 from among the sub character candidates retained by the player.

Specifically, the player can set, as the sub characters 70, a first sub character 70a, a second sub character 70b, a third sub character 70c, a fourth sub character 70d, and a fifth sub character 70e. Each sub character 70 (sub character candidate) is linked with a display appearance in the game screen, an attack motion, various parameters such as attack power, a character's skill, etc.

Although details are described below, in this embodiment, the main character 60 itself does not carry out the attack motion but the sub characters 70 carry out the attack motion. However, unlike the main character 60, the sub characters 70 have no set HP parameters. Thus, the enemy character cannot inflict damage on the sub characters 70. In addition, the target of the hit judgement of whether the attack from the enemy character has hit the character or not is the main character 60 only. In other words, the sub characters 70 are not the targets of the hit judgement by the attack from the enemy character.

Although not illustrated in the drawings, at the start of the fever mode, an animation of the main character 60 absorbing the sub characters 70 and transforming into a special character is displayed. Thus, during the fever mode, that is, while the special character is being displayed, the sub characters 70 are not displayed. When the fever mode ends, all of the sub characters 70 reappear as the special character returns to the main character 60.

Alternatively, depending on the sub characters 70 set, the display appearance of the special character may change. Yet alternatively, depending on the sub characters 70 set, the performance of the special character may change. Examples of the performance of the special character include attack motions, that is, attack animations, and various parameters such as attack power.

Furthermore, sub character icons 72 are displayed in the lower portion of the game screen. The sub character icons 72 include a first sub character icon 72a, a second sub character icon 72b, a third sub character icon 72c, a fourth sub character icon 72d, and a fifth sub character icon 72e. The first sub character icon 72a, the second sub character icon 72b, the third sub character icon 72c, the fourth sub character icon 72d, and the fifth sub character icon 72e respectively correspond to the first sub character 70a, the fourth sub character 70d, and the fifth sub character 70e. In the sub character icons 72, the corresponding sub characters 70 are indicated in an identifiable manner.

Furthermore, the player can set special skills. Specifically, the player can set, as special skills, character's skills linked with sub character candidates retained by the player. The player can set up to two special skills. Examples of the character's skill linked to a sub character candidate include an attack skill that inflicts significant damage on the enemy character and a recovery skill that recovers the HP of the main character 60.

Two special skill icons 74 are displayed in the lower right portion of the game screen. In the special skill icons 74, images corresponding to the sub character candidates that have the character's skills set by the player are displayed. Furthermore, a skill gauge 76 is displayed above each of the two special skill icons 74.

The skill gauge 76 visually indicates the proportion of the current value of the skill point with respect to the maximum value. The skill point is a parameter set for the main character 60 and rises when a particular condition is satisfied. Here, to inflict damage on the boss character 50 is set as the particular condition. The skill point is given according to the damage inflicted on the boss character 50, in other words, the decrease in HP of the boss character 50.

The particular condition that raises the skill point is not limited to this. For example, the skill point may rise every time a particular time period elapses. Alternatively, for example, the particular condition set for raising the skill point may be that the main character 60 is damaged, that an enemy character other than the boss character 50 is damaged, that a particular enemy character including the boss character 50 is taken down, that an item is used, etc. The particular condition that raises the skill point and the rate of increase in skill point differ for each character's skill.

When the skill point reaches the maximum value, a skill activation condition is satisfied. The special skill becomes usable when the skill activation condition is satisfied. In the state where the skill activation condition is satisfied, the player can selectively activate two special skills by inputting a skill activation operation. Once the special skills are activated, the skill points corresponding to the activated special skills are updated to the initial values.

In this embodiment, the state of the game is roughly divided into an in-game and an out-game. An in-game means the state in which the normal stage and the boss stage are being played. In contrast, an out-game means the state in which the player can purchase items, sub character candidates, etc., used in the in-game and in which the normal stage or the boss stage is not being played. When the player transitions to an in-game, the player can use the item purchased in the out-game or set sub characters 70 and special skills. In addition, during the in-game, the player can change or add sub characters 70.

During the out-game, the player can set the sub characters 70 and the special skills. Alternatively, in the out-game, setting and purchasing of the sub characters 70 and the special skills may be prohibited. In such a case, the sub characters 70 and the special skills can be set and purchased only during the in-game.

Here, when the transition from an in-game to an out-game occurs, the retained sub character candidates are basically lost. In other words, sub character candidates purchased in the out-game can only be used during the next one in-game. Alternatively, sub character candidates that are purchased and sub character candidates that are acquired in the in-game may be usable repeatedly during the in-games. Similarly, the items may be usable during one in-game only or usable repeatedly during the in-games.

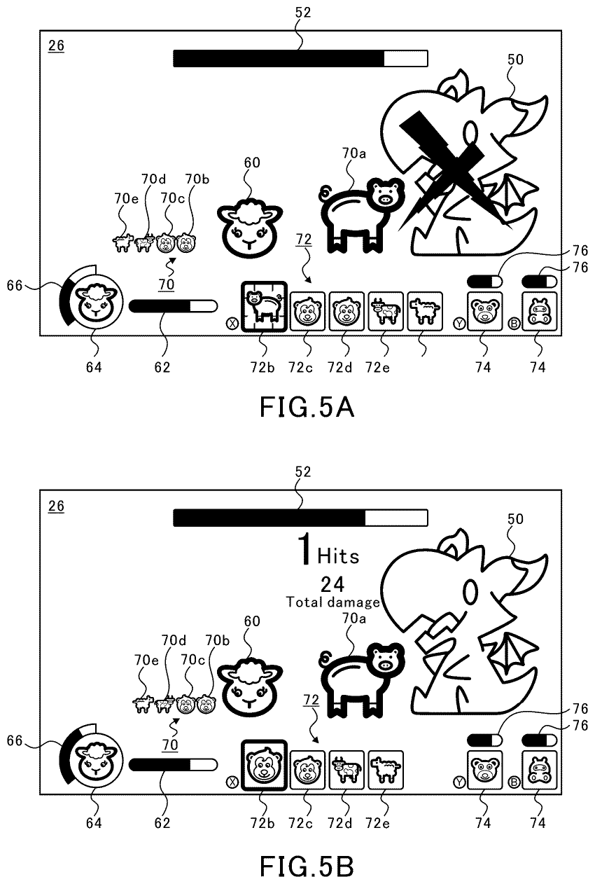

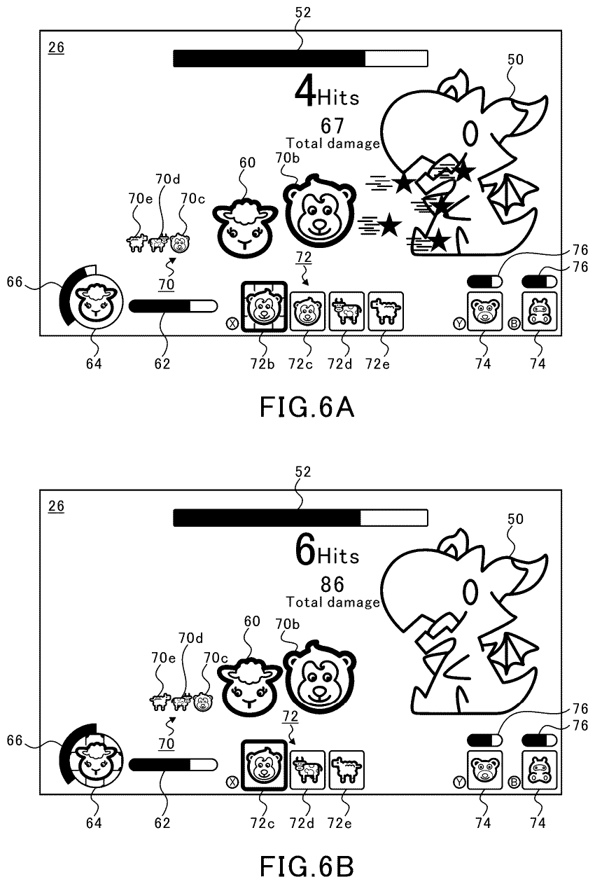

FIG. 5A is a first diagram illustrating an attack motion of a sub character 70. FIG. 5B is a second diagram illustrating an attack motion of a sub character 70. FIG. 6A is a third diagram illustrating an attack motion of a sub character 70. FIG. 6B is a fourth diagram illustrating an attack motion of a sub character 70. When the player inputs an attack operation, the sub character 70 carries out the attack motion. Here, in response to one input of the attack operation, one of the sub characters 70 carries out an attack motion.

As illustrated in FIG. 5A, the characters are lined up with the main character 60 at the head, followed by the first sub character 70a, the second sub character 70b, the third sub character 70c, the fourth sub character 70d, and the fifth sub character 70e in this order. Here, the attack motion is carried out in the order of the first sub character 70a, the second sub character 70b, the third sub character 70c, the fourth sub character 70d, and the fifth sub character 70e. In other words, here, the order in which the sub characters 70 are lined up and the order in which the attack motion is carried out are coincident. Alternatively, the order in which the attack motion is carried out may be set at random irrespective of the order of lining.

For example, suppose that an attack operation has been input and an attack motion of the first sub character 70a is carried out. In such a case, as illustrated in FIG. 5A, an attack animation of the first sub character 70a attacking the enemy character is displayed. A successful attack motion inflicts damage on the enemy character. When damage is inflicted on the enemy character, as illustrated in FIG. 5B, the number of hits (in FIG. 5B, indicated as “1 Hits”), which is the number of times damage is inflicted, and the total value of the inflicted damage (in FIG. 5B, indicated as “24 Total damage”) are displayed.

In addition, while the attack animation of the first sub character 70a is being displayed, the second to fifth sub characters 70b to 70e move closer to the main character 60. When this happens, the first sub character icon 72a disappears, and the second to fifth sub character icons 72b to 72e shift toward the left.

Here, during the period from the input of the attack operation of the first sub character 70a until the end of the attack animation of the first sub character 70a, an invalid period and a combination accepting period are set. The invalid period is the period starting from the input of the attack operation of the first sub character 70a and lasting until a first time period elapses. During this invalid period, the next attack operation is invalidated. In other words, an attack motion does not start even when an attack operation is input during the invalid period.

In contrast, the combination accepting period is a period lasting until the attack animation ends after the first time period has elapsed. During this combination accepting period, a next attack operation is valid. For example, suppose that a next attack operation has not been input during the period starting from the input of the attack operation of the first sub character 70a and lasting until the attack animation of the first sub character 70a ends. In such a case, a particular standby period is set after the end of the attack animation, that is, the attack motion, of the first sub character 70a. After the standby period has elapsed, the first sub character 70a returns to the game screen. Here, as with before the input of the attack operation, the first to fifth sub characters 70a to 70e line up.

Along with the return of the first sub character 70a, as with before the input of the attack operation, the first to fifth sub character icons 72a to 72e are displayed. When an attack operation is input again after the first sub character 70a has returned to the game screen, the attack animation of the first sub character 70a is run in the same manner as above.

Meanwhile, suppose that a next attack operation has been input during the combination accepting period before the attack animation of the first sub character 70a ends. In such a case, an attack motion of the second sub character 70b starts before the attack motion of the first sub character 70a ends. Specifically, as illustrated in FIG. 6A, an attack animation of the second sub character 70b carrying out an attack on the enemy character is displayed. Here, although not illustrated in the drawings, at the start of displaying the attack animation of the second sub character 70b, the attack animation of the first sub character 70a is being displayed. In addition, an attack motion set for a sub character 70 is either an attack motion that can inflict damage only once or an attack motion that can inflict damage multiple times in one attack motion. When damage is inflicted multiple times in one attack motion, the number of times damage is inflicted is cumulated as the number of hits, and the cumulated number of hits is displayed.

Here, when an attack operation is input during the combination accepting period, a combination valid state emerges. In other words, when multiple sub characters 70 sequentially carry out attacks at intervals within a particular period of time, the combination valid state emerges. In the combination valid state, for example, damage inflicted on the enemy character is intensified. In addition, in the combination valid state, the total value of the number of hits and damage is accumulated across the attack motions of the multiple sub characters 70.

While the attack animation of the second sub character 70b is being displayed, the third to fifth sub characters 70c to 70e move closer to the main character 60. At this time, the second sub character icon 72b is removed, and the third to fifth sub character icons 72c to 72e shift toward the left.

During the attack motion of the second sub character 70b also, an invalid period and a combination accepting period are set. When a next attack operation is input during the combination accepting period, as described above, the combination valid state continues, and, during the attack motion of the second sub character 70b, an attack motion of the third sub character 70c starts.

As such, the player can keep up the combination valid state by inputting the next attack operation during the combination accepting period. Here, the combination valid state lasts at most until the attack motion of the fifth sub character 70e ends. Thus, during the attack motion of the fifth sub character 70e, no combination accepting period is set, and only the invalid period is set. As a result, the combination valid state ends as soon as the attack motion of the fifth sub character 70e ends.

After the attack motion of the fifth sub character 70e is carried out, the fifth sub character 70e is removed from the game screen, and, as a result, all of the sub characters 70 and sub character icons 72 are removed from the display. After a particular standby period has elapsed after all of the sub characters 70 and sub character icons 72 have disappeared, the characters line up with the main character 60 at the head, followed by the first sub character 70a, the fourth sub character 70d, and the fifth sub character 70e in this order. As a result, the player can resume carrying out attack motions in sequence from the first sub character 70a.

As such, in this embodiment, a combination valid state is created by inputting an attack operation during the combination accepting period. By continuing the combination valid state, the attack motion can be carried out in sequence from the first to fifth sub characters 70a to 70e.

Meanwhile, when an attack operation has not been input during the combination accepting period, the combination valid state ends at the end of the attack motion currently being carried out. In such a case, the sub character 70 that has carried out the attack motion returns to the game screen after a standby period. At that stage, the sub characters 70 assume the initial lined-up state, and the attack motion is carried out again from the first sub character 70a.

In the combination valid state, attack motions of multiple sub characters 70 are carried out concurrently. Thus, by keeping up the combination valid state, the time taken to carry out multiple attack motions is shortened. In other words, by keeping up the combination valid state, more attack motions can be carried out within a particular period of time, and the game can progress in favor of the player.

The boss stage is cleared when the HP of the sub characters 70 decreases to zero. Rewards are given to the player by clearing the boss stage. The rewards given here include sub character candidates.

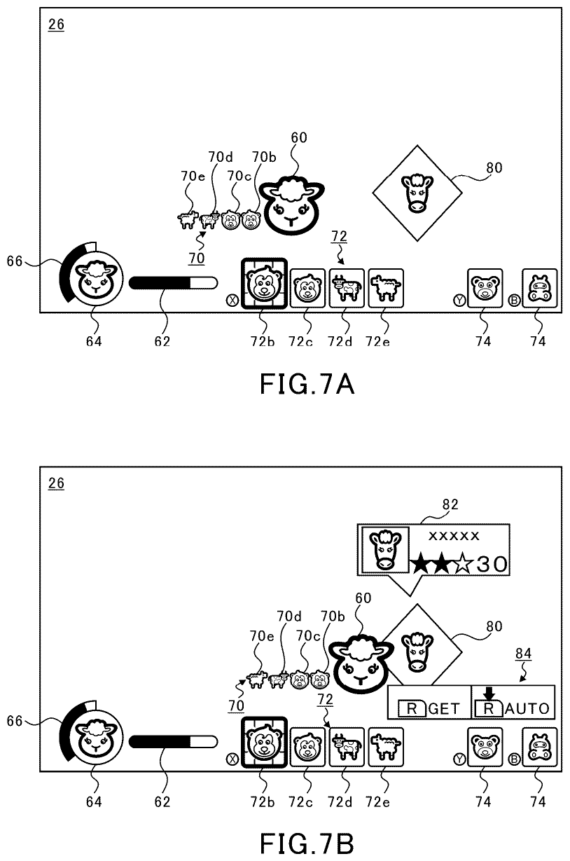

FIG. 7A is a diagram illustrating the game screen that appears when the boss stage is cleared, and FIG. 7B is a diagram illustrating the game screen that appears when a sub character candidate is acquired. When the boss stage is cleared, a reward to be given to the player is determined. Note that, in the boss stage, a reward selected by a lottery may be given or a reward preset for each boss stage may be given. As illustrated in FIG. 7A, a reward icon 80 is displayed in the game screen when the boss stage is cleared. In the reward icon 80, an image that can identify the content of the reward is displayed.

FIG. 7A illustrates the case in which a sub character candidate is given as a reward. Thus, an image corresponding to the sub character candidate is displayed in the reward icon 80. The player can move the main character 60 even in the state in which the reward icon 80 is being displayed. As illustrated in FIG. 7B, when the player inputs a move operation and the main character 60 thereby moves closer to the reward icon 80, a reward detail image 82 and an operation guide 84 appear.

The reward detail image 82 is an image that illustrates the content of the reward. Here, the image, name, strength value, and evolution level (described later) of the sub character candidate are displayed in the reward detail image 82. The operation guide 84 indicates the operation related to the acquisition of the reward. The player can select whether to acquire and retain the reward or leave the reward unacquired. The player can acquire and retain the reward by pressing the side button 36 once while the main character 60 is close to the reward icon 80.

When the reward is a sub character candidate, the player can acquire and retain the sub character candidate, and activate a sub character 70 automatic organization function. When the player long-presses the side button 36 while the main character 60 is close to the reward icon 80, the reward is acquired and retained and, in addition, the automatic organization function is activated. The automatic organization function is a function of setting sub characters 70 into a what is considered optimum combination and sequence from among the sub character candidates retained by the player. In the operation guide 84, the operation for acquiring and retaining the reward without activating the automatic organization function and the operation for acquiring and retaining the reward and activating the automatic organization function are displayed in an identifiable manner. The sub character 70 automatic organization function is described in detail below.

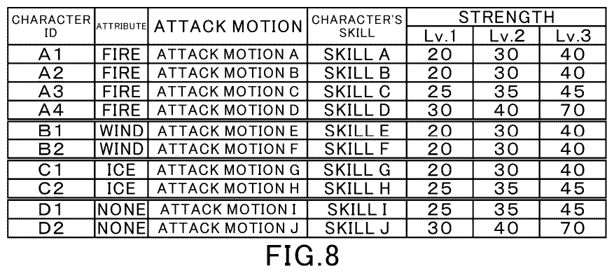

FIG. 8 is a table of sub characters 70. In FIG. 8, some of the sub character candidates that can be set as the sub characters 70 are indicated. As indicated in FIG. 8, each sub character candidate is linked with a character ID, an attribute, an attack motion, a character's skill, and an evolution level. Various pieces of information other than the information indicated in FIG. 8 are further linked with each sub character candidate.

The character ID is information for identifying the type of the sub character candidate. The attribute is a feature of the sub character candidate and also serves as information for classifying the sub character candidate. Here, every sub character candidate is classified into one of four attributes: “Fire”, “Wind”, “Ice”, and “None”. As with the sub character candidates, enemy characters may also be linked with attributes. In such a case, depending on the combination of the attribute of the sub character 70 and the attribute of the enemy character, how advantageously the game plays out changes, such as the inflicting larger damage. When the attribute of the enemy character that emerges differs from one stage to another, the optimum organization of the sub characters 70 differs. Thus, strategic considerations are required in organizing the sub characters 70, and this makes the game more interesting.

Each sub character candidate is linked with one attack motion and one character's skill. Alternatively, there may be a sub character candidate linked with multiple attack motions or a sub character candidate linked with multiple character's skills. The attack motion linked with the sub character candidate is carried out when an attack operation is input in a state set for the sub character 70. Moreover, the character's skill linked with the sub character candidate can be set as the aforementioned special skill.

Here, each attack motion has different attack animation and attack power. Moreover, for each attack motion, a motion time, which is the time taken for the attack motion to end, is set. The attack motions include those having different motion times. Furthermore, as described above, during the attack motion, an invalid period and a combination accepting period are set. The attack motions include those which have different lengths of the invalid period, that is, the lengths of time in which the attack operation is invalid, and/or different lengths of the combination accepting period.

Each sub character candidate is linked with a strength value for each evolution level. The player can raise the evolution level by evolving the sub character 70 as the game progresses. The evolution level rises by using items acquired in each stage. For example, suppose that the player has cleared the boss stage and acquired and retained a sub character candidate as a reward. Here, an evolution level is preset for the acquired sub character candidate. The player acquires a sub character candidate of evolution level 1 in some cases and a sub character candidate of evolution level 3 in other cases.

The maximum value of the evolution level for the sub character candidate is 3. Thus, when the evolution level of the sub character candidate is 1 or 2, the player can raise the evolution level of this sub character candidate by using an item or the like. Here, the player can raise the evolution level of a sub character candidate set as the sub character 70 or a sub character candidate not set as the sub character 70.

The condition for raising the evolution level is not limited to the use of items. For example, the evolution level of a newly acquired sub character candidate may rise when this new sub character candidate is the same sub character candidate as the one the player already retains. Specifically, suppose that the player retains one sub character candidate of evolution level 1. In such a case, when the same sub character candidate is newly acquired, the number of this sub character candidates retained is 2. Then the evolution levels of both of these sub character candidates rise to level 2.

The strength value is a parameter determined on the basis of the rarity of the sub character candidate, attack power, information used in the hit judgement, etc., for example. Here, the strength value is set to increase with the increase in evolution level.

In addition, a display appearance corresponding to each evolution level is set for the sub character candidate. In other words, as the evolution level rises, the display appearance of the sub character 70 displayed in the game screen changes. Note that the attack animation displayed when the attack motion is carried out is the same irrespective of the evolution level. Alternatively, the attack animation may change depending on the evolution level.

Irrespective of the evolution level, the operation necessary to carry out the attack motion is the same. In other words, the player can carry out the attack motion by the same attack operation irrespective of the evolution level. That is, although the display appearance changes as the evolution level rises, the attack operation for carrying out the attack motion remains unchanged. Accordingly, the player is not required to carry out cumbersome operations and the game can become more interesting due to a variety in display appearance.

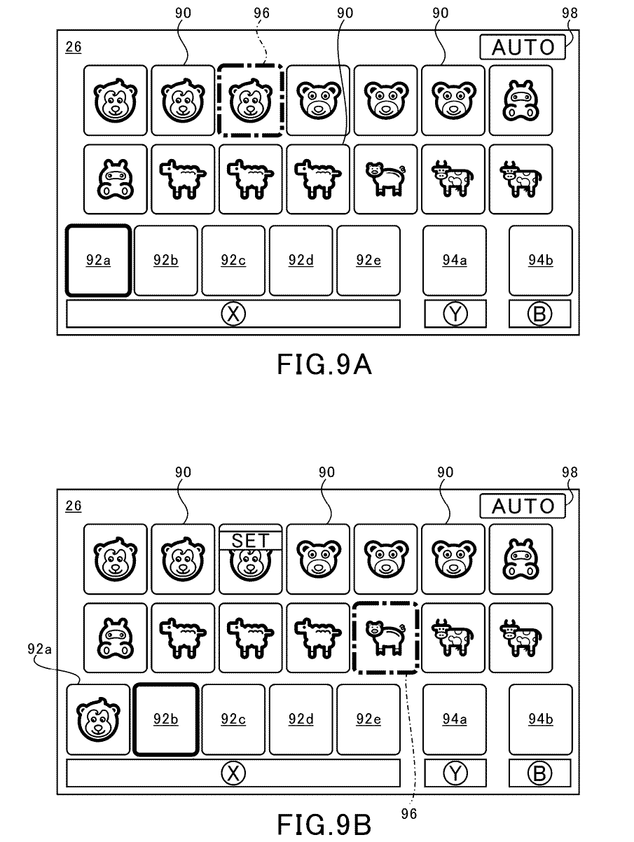

FIG. 9A is a first diagram illustrating an organization screen. FIG. 9B is a second diagram illustrating the organization screen. As described above, the player can organize sub characters 70 during the in-game and the out-game. When a particular operation is input during the in-game and the out-game, an organization screen illustrated in FIG. 9A appears on the display 26.

Retain icons 90 corresponding to the sub character candidates retained by the player are displayed in the upper portion of the organization screen. In other words, a list of sub character candidates retained by the player is displayed in the organization screen. Note that information regarding the strength value and the attack motion may be displayed in the retain icons 90. For example, a still image or a movie clip indicating the attack animation may be displayed as the information regarding the attack motion.

In addition, a first sub character setting box 92a, a second sub character setting box 92b, a third sub character setting box 92c, a fourth sub character setting box 92d, a fifth sub character setting box 92e, a first special skill setting box 94a, and a second special skill setting box 94b are displayed in the lower portion of the organization screen.

The first to fifth sub character setting boxes 92a to 92e respectively correspond to the first to fifth sub characters 70a to 70e. In short, the sub character candidate set in the first sub character setting box 92a becomes the first sub character 70a, and the sub character candidates set in the second to fifth sub character setting boxes 92b to 92e respectively become the second to fifth sub characters 70b to 70e.

The first special skill setting box 94a and the second special skill setting box 94b respectively correspond to the two special skill icons 74 displayed in the game screen. In other words, the character's skills of the sub character candidates set in the first special skill setting box 94a and the second special skill setting box 94b become special skills.

In the organization screen, a cursor 96 indicated by a surrounding one-dot chain line in the drawing is displayed. The player can, for example, align the cursor 96 on any one of the retain icons 90 and the first sub character setting box 92a to the second special skill setting box 94b by tilting the tilt operation unit 34.

For example, suppose that the right button 32c has been pressed while the cursor 96 is aligned on the first sub character setting box 92a. This puts the first sub character setting box 92a in a temporarily selected state, and, as illustrated by a surrounding solid line in the drawing, the first sub character setting box 92a is highlighted. Suppose that after the cursor 96 is aligned on the retain icon 90, the right button 32c is pressed in this state. In this case, as illustrated in FIG. 9B, the retain icon 90 with the cursor 96 aligned thereon is displayed in the first sub character setting box 92a. As a result, the sub character candidate selected by the player is set in the first sub character setting box 92a, that is, set to be the first sub character 70a.

As described above, the player can set up to five sub characters 70 and two special skills by selecting the retain icons 90 after putting the first sub character setting box 92a to the second special skill setting box 94b displayed in the lower portion of the organization screen in a temporarily selected state.

The player can retain two or more of the same sub character candidates. Moreover, when the player retains two or more of the same sub character candidates, the player can set up to three of the same sub character candidates as the sub characters 70. Alternatively, redundant setting may not be permitted for the sub characters 70. Similarly, the character's skills of the same sub character candidates may be set as the two special skills. Alternatively, redundant setting may not be permitted for the two special skills.

In addition, the player does not have to always set five sub characters 70. The player can set one or more and five or less sub characters 70. Furthermore, the player does not have to always set two special skills. The player can set zero to two special skills.

An automatic organization button 98 is displayed in the upper right portion of the organization screen. When the right button 32c is pressed in the state where the cursor 96 is aligned on the automatic organization button 98, the automatic organization function is activated. Furthermore, as described above, the automatic organization function is also activated when the side button 36 is long-pressed in the state where the operation guide 84 is displayed by clearing the boss stage. According to the automatic organization function, the sub characters 70 and the like are set on the basis of the first setting information, the combination setting information, the attributes set for the sub character candidates, etc.

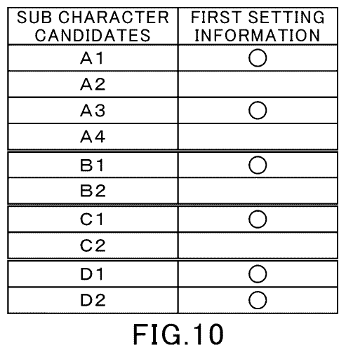

FIG. 10 is a table of the first setting information. The first setting information table is stored in the memory 12 or the storage unit 18 of the player terminal 1. In the first setting information table, some of the sub character candidates provided in the game are preliminarily linked with the first setting information. According to the automatic organization function, basically, the sub character candidates are sequentially set from the head setting box to the tail end setting box with the first sub character setting box 92a being the head setting box and the fifth sub character setting box 92e being the tail end setting box.

In other words, according to the automatic organization function, first, the sub character candidate to be set in the first sub character setting box 92a, that is, the first sub character 70a, is selected. At this time, a sub character candidate to be preferentially set in the first sub character setting box 92a is linked with the first setting information. For example, in the example illustrated in FIG. 10, the sub character candidates A1, A3, B1, C1, D1, and D2 are linked with the first setting information. As such, the sub character candidates include those sub character candidates that are linked with the first setting information and those sub character candidates that are not linked with the first setting information.

According to the automatic organization function, first, one sub character candidate linked with first setting information is selected as the sub character candidate to be set in the first sub character setting box 92a. Next, on the basis of the selected sub character candidate, sub character candidates to be set in the second to fifth sub character setting boxes 92b to 92e are respectively selected.

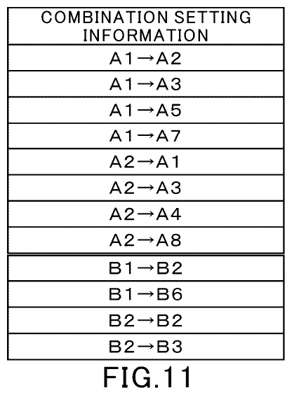

FIG. 11 is a table of combination setting information. A combination setting information table is stored in the memory 12 or the storage unit 18 of the player terminal 1. The combination setting information table stores multiple pieces of combination setting information. The combination setting information is information that specifies a sub character candidate to be preferentially placed next to a previously selected sub character candidate. The combination setting information can be rephrased as the information specifying two sub character candidates to be preferentially placed in sequence.

For example, in the example indicated in FIG. 11, sub character candidates A2, A3, A5, and A7 are specified as the sub character candidates to be preferentially placed next to the sub character candidate A1. In addition, for example, sub character candidates A1, A3, A4, and A8 are specified as the sub character candidates to be preferentially placed next to the sub character candidate A2. According to the automatic organization function, sub character candidates are set in the first to fifth sub character setting boxes 92a to 92e, the first special skill setting box 94a, and the second special skill setting box 94b by referring to the aforementioned first setting information and combination setting information.

Here, the combination setting information is designed by taking into account how easily the combination valid state is created and continues, for example. Furthermore, the combination setting information is designed by taking into account the visual appeal of the attack animation played when the attack motions are sequentially carried out in the combination valid state. As described above, an invalid period during which the input of the next attack operation is invalid is set for each of the attack motions. The duration of the invalid period can be different from one attack motion to another. In this embodiment, for example, the attack motions are classified into weak attack motions, intermediate attack motions, and strong attack motions.

A weak attack motion is an attack motion that has low attack power but has a short invalid period set therefor. An intermediate attack motion is an attack motion that has higher attack power and a longer invalid period set therefor than the weak attack motion. A strong attack motion is an attack motion that has higher attack power and a longer invalid period than the intermediate attack motion. The weak attack motion is set to take a shorter time from the start to the end of the attack motion compared to the intermediate attack motion and the strong attack motion.

Since the weak attack motion has a short invalid period, the time taken until the next attack motion can start is short. Thus, for example, when the sub characters 70 with the weak attack motions set therefor are sequentially placed, two attack motions are executed in a shorter time than in the case in which sub characters 70 with the strong attack motions set therefor are sequentially placed.

According to the automatic organization function, first setting information is attached to a sub character candidate for which a weak attack motion is set so that the combination valid state can be created earlier. In this manner, according to the automatic organization function, a sub character candidate for which a weak attack motion having a short invalid period is set is always set as the first sub character 70a.

Furthermore, the combination setting information is set, for example, so that the motions flow from a weak attack motion to a weak attack motion, from a weak attack motion to an intermediate attack motion, from an intermediate attack motion to an intermediate attack motion, an intermediate attack motion to a strong attack motion, and a strong attack motion to a strong attack motion. In this manner, the sub characters 70 are set so that the attack power intensifies toward the latter half of the combination valid state while promoting continuation of the combination valid state.

Moreover, an attack animation to be displayed in the game screen and hit judgement information are set for an attack motion set for a sub character candidate. The hit judgement information is information for executing a hit judgement process of judging whether the attack motion that has been carried out succeeds or not. For example, the hit judgement information includes parameters used in a computation process for judging whether the attack motion succeeds or not. The hit judgement information also includes a standby time taken until the hit judgement process is executed after the attack motion is carried out. This standby time differs depending on the type of the attack motion. Here, the weak attack motion is set to have a shorter standby time until the hit judgement process is executed compared to the intermediate attack motion and the strong attack motion.

Thus, when an attack operation is input, the time taken until the hit judgement process is executed, that is, the time taken until damage is inflicted on the enemy character, differs depending on the attack motion. Moreover, since the attack animation differs from one attack motion to another, depending on the content of the attack animation, the visual appearance is degraded if the attack motions are sequentially carried out.

As such, operational ease, issues with visual appearance, and the order of two sequential attack motions that does not affect occurrence and continuance of the combination valid state are preset as the combination setting information by taking into account various pieces of information. In other words, the combination setting information is designed by taking into account the smoothness of the flow of the attack motions on the basis of the attack motion, the hit judgement information, and the attack animation.

However, phenomena taken into account in designing the combination setting information are not particularly limited. For example, the combination setting information may be designed by taking into account inflicting the maximum damage on the enemy character. In the description below, the sub character 70 selection process executed by the automatic organization function is described through one example.

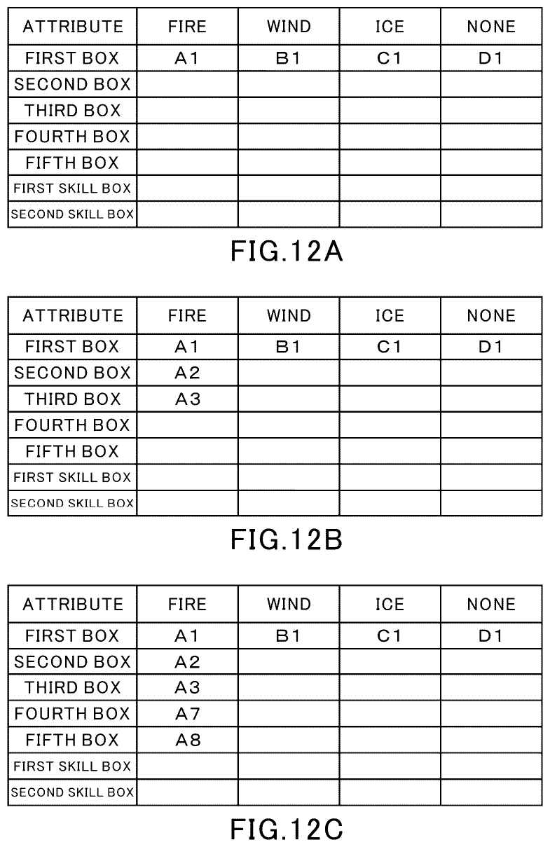

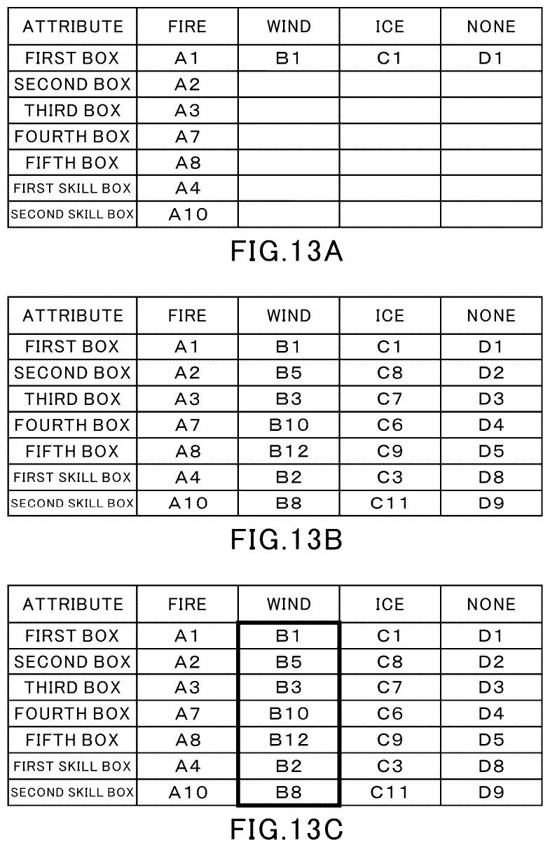

FIG. 12A is a first diagram illustrating an example of the sub character candidate selection process executed by the automatic organization function. FIG. 12B is a second diagram illustrating the example of the sub character candidate selection process executed by the automatic organization function. FIG. 12C is a third diagram illustrating the example of the sub character candidate selection process executed by the automatic organization function. FIG. 13A is a fourth diagram illustrating the example of the sub character candidate selection process executed by the automatic organization function. FIG. 13B is a fifth diagram illustrating the example of the sub character candidate selection process executed by the automatic organization function. FIG. 13C is a sixth diagram illustrating the example of the sub character candidate selection process executed by the automatic organization function.

According to the automatic organization function, the sub characters 70 and the special skills are organized according to the attributes of the sub character candidates. Since there are four attributes linked with sub character candidates, the sub characters 70 and the special skills are temporarily organized into four patterns here. Of the four patterns temporarily organized, the one having the highest total strength value is set. Specifically, under each attribute, a sub character candidate having the highest strength value among the sub character candidates linked with the first setting information is temporarily set in the first sub character setting box 92a.

Here, as illustrated in FIG. 12A, a sub character candidate A1 is temporarily set under the attribute Fire, a sub character candidate B1 is temporarily set under the attribute Wind, a sub character candidate C1 is temporarily set under the attribute Ice, and a sub character candidate D1 is temporarily set under the attribute None. In this embodiment, a sub character candidate of the attribute Fire is denoted by An, and, likewise, sub character candidates of the attributes Wind, Ice, and None are respectively denoted by Bn, Cn, and Dn. Here, n in the sub character candidates An, Bn, Cn, and Dn is any desired integer and indicates the character ID.

After a sub character candidate is temporarily set in the first sub character setting box 92a under each attribute, sub character candidates are temporarily set in the second sub character setting box 92b to the second special skill setting box 94b. Here, sub character candidates are temporarily set in the second sub character setting box 92b to the second special skill setting box 94b in the order of the attribute Fire, the attribute Wind, the attribute Ice, and the attribute None.

When temporarily setting a sub character candidate of the attribute Fire, first, a sub character candidate is temporarily set in the second sub character setting box 92b. Here, the sub character candidate is extracted on the basis of the combination setting information. Specifically, a sub character candidate to be preferentially placed next to the sub character candidate A1 temporarily set in the first sub character setting box 92a is extracted. In other words, a sub character candidate for which the combination setting information “A1→An” is set is extracted.

Note that there may be more than one sub character candidates to be preferentially placed next to the sub character candidate A1. In such a case, one sub character candidate is temporarily set according to a preset condition, such as having the highest strength value, for example. Here, as illustrated in FIG. 12B, the sub character candidate A2 for which the combination setting information “A1→A2” is set is temporarily set in the second sub character setting box 92b.

After a sub character candidate is temporarily set in the second sub character setting box 92b, a sub character candidate is temporarily set in the third sub character setting box 92c. In this case, a sub character candidate to be preferentially placed next to the sub character candidate in the second sub character setting box 92b temporarily set to be the tail end box at this stage is extracted. Here, a sub character candidate A3 for which the combination setting information “A2→A3” is set is temporarily set in the third sub character setting box 92c. Note that, when sub character candidates are temporarily set in the two consecutive setting boxes, a sub character candidate that can be set between these two sub character candidates may be retrieved.

As such, sub character candidates are temporarily set in the second to fifth sub character setting boxes 92b to 92e on the basis of the combination setting information. However, there may be instances where no sub character candidate to be preferentially placed is extracted on the basis of the combination setting information. In other words, there may be instances where a sub character candidate to be preferentially placed next to the sub character candidate temporarily set in the tail end box at this stage is not extracted. As such, if no sub character candidates having connections are extracted, remaining sub character candidates are temporarily set in the empty boxes among the second to fifth sub character setting boxes 92b to 92e.

Here, if there are two or more empty boxes, sub character candidates are extracted on the basis of the combination setting information in such a way as to establish a connection between the sub character candidates in the empty boxes. For example, suppose that a sub character candidate to be preferentially placed next to the sub character candidate A3 temporarily set in the third sub character setting box 92c has not been extracted. In such a case, the fourth sub character setting box 92d and the fifth sub character setting box 92e remain empty.

In such a case, two sub character candidates that have connections are extracted on the basis of the combination setting information. Here, since the combination setting information “A7→A8” is set, as illustrated in FIG. 12C, sub character candidates A7 and A8 are respectively temporarily set in the fourth sub character setting box 92d and the fifth sub character setting box 92e.

When multiple sets of two sub character candidates having connections are extracted, the sub character candidates may be temporarily set according to a preset condition. For example, a set of two sub character candidates that has the highest total strength value may be temporarily set. If two sub character candidates having a connection are not extracted, for example, sub character candidates may be temporarily set in the empty boxes sequentially in descending order of the strength value.

If sub character candidates of the attribute Fire are deficient, sub character candidates of other attributes may be temporarily set in the empty boxes. In such a case, sub character candidates may be set in the empty boxes sequentially in descending order of the strength value. If mixing of sub character candidates with multiple attributes is to be avoided, no sub character candidates may be temporarily set in the empty boxes.

As such, after the sub character candidates are temporarily set in the first to fifth sub character setting boxes 92a to 92e under the attribute Fire, sub character candidates are temporarily set in the first special skill setting box 94a and the second special skill setting box 94b. Here, as illustrated in FIG. 13A, sub character candidates of the attribute Fire not temporarily set in the first to fifth sub character setting boxes 92a to 92e are temporarily set in the first special skill setting box 94a and the second special skill setting box 94b.

Here, the method for selecting sub character candidates to be temporarily set is not particularly limited. For example, the order of preference may be set for the character's skills, and the sub character candidates to be temporarily set in the first special skill setting box 94a and the second special skill setting box 94b may be determined according to this order of preference. Alternatively, the sub character candidates to be temporarily set in the first special skill setting box 94a and the second special skill setting box 94b may be determined in the order of the character ID.

When the sub character candidates are temporarily set in the first sub character setting box 92a to the second special skill setting box 94b under the attribute Fire, as illustrated in FIG. 13B, sub character candidates are temporarily set as described above under the attribute Wind, the attribute Ice, and the attribute None. After sub character candidates are temporarily set under all of the attributes, the total strength values are compared between the attributes. Here, the strength values of the temporarily set sub character candidates are totaled to obtain a total strength value. Then, one organization of the attribute having the highest total strength value is determined.

For example, when the total strength value of the attribute Wind is the highest, as indicated by a surrounding solid line in FIG. 13C, the temporary settings of the attribute Wind are officially determined as the sub characters 70 and the special skills. Accordingly, in such a case, the sub character candidate B1 is set to be the first sub character 70a, and the sub character candidates B5, B3, B10, and B12 are respectively determined to be the second to fifth sub characters 70b to 70e. Furthermore, the character's skills of the sub character candidates B2 and B8 are determined as the special skills.

As such, in this embodiment, sub characters 70 with which the combination valid state is likely to be maintained are automatically organized by the automatic organization function. As a result, the convenience of the player is improved. Here, temporary setting of the sub characters 70 is conducted for each attribute, and then one of the attributes is officially determined. Alternatively, the sub characters 70 may be organized without considering the attributes. Yet alternatively, for example, the player may be able to preliminarily set the attributes of the sub characters 70 to be set by the automatic organization function. In such a case, the aforementioned process may be performed on only the sub characters 70 that match the attributes set by the player.

Next, the functional configuration of the player terminal 1 for running the aforementioned game is described. By the way,

### Functional Configuration of Player Terminal 1

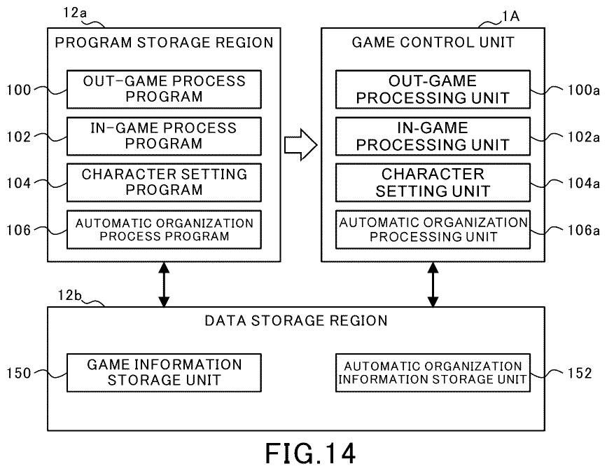

FIG. 14 is a diagram illustrating the configuration of the memory 12 in the player terminal 1 and the function thereof as a computer. The memory 12 includes a program storage region 12a and the data storage region 12b. When the game is started, the CPU 10 stores a program (module) for controlling the game in the program storage region 12a.

The program for controlling the game includes an out-game process program 100, an in-game process program 102, a character setting program 104, and an automatic organization process program 106. Note that the programs listed in FIG. 14 are mere examples and many of other programs may be included in the program for controlling the game.

The data storage region 12b includes, as the storage units that store data, a game information storage unit 150 and an automatic organization information storage unit 152. In addition, many other storage units are included in the data storage region 12b. Here, various pieces of the game information necessary for the progress of the game are stored in the game information storage unit 150. For example, the game information includes information regarding the retained sub character candidates, the evolution level of each sub character candidate, and setting information of the sub characters 70 and the special skills.

The automatic organization information storage unit 152 is used when the automatic organization function is activated, and stores information regarding the temporary settings of the sub character candidates.

The CPU 10 runs the programs stored in the program storage region 12a and updates the information in the storage units in the data storage region 12b. In addition, the CPU 10 runs the programs stored in the program storage region 12a so that the player terminal 1 (computer) functions as a game control unit 1A. The game control unit 1A includes an out-game processing unit 100a, an in-game processing unit 102a, a character setting unit 104a, and an automatic organization processing unit 106a.

Specifically, the CPU 10 runs an in-game process program 100 so that the computer functions as the out-game processing unit 100a. In the same manner, the CPU 10 runs the character setting program 102, the character setting program 104, and the automatic organization process program 106 so that the computer also functions as the in-game processing unit 102a, the character setting unit 104a, and the automatic organization processing unit 106a.

The out-game processing unit 100a executes processes during the out-game. The in-game processing unit 102a executes processes during the out-game. The character setting unit 104a executes processes of setting sub characters 70, etc., in response to the player's operation. The automatic organization processing unit 106a executes the automatic organization process and automatically organizes the sub characters 70 etc. If, for example, the game proceeds by collaboration between the player terminals 1 and the server 1000, such as in the case of an on-line game, the functional units illustrated in FIG. 14 may be provided in one or both of the player terminals 1 and the server 1000.

The processes executed by the individual functional units in the player terminal 1 described above will now be described with reference to the flowcharts. Here, as examples of the processes in the game, a process related to settings of the sub characters 70 and the process related to the boss stage are described.

### Processes in Player Terminal 1

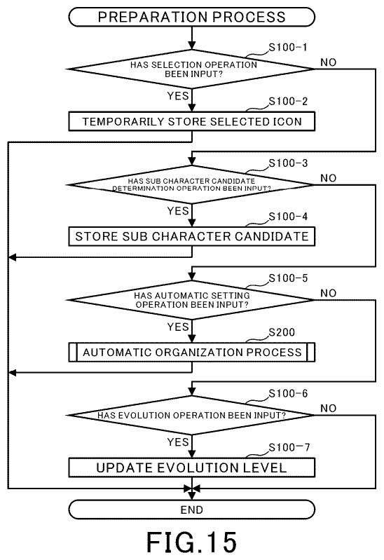

FIG. 15 is a flowchart indicating a preparation process. During the in-game or out-game, when an operation commanding the organization screen illustrated in FIGS. 9A and 9B [to?] be displayed is input, the character setting unit 104a displays the organization screen. When a selection operation of selecting one box out of the first sub character setting box 92a to the second special skill setting box 94b is input while the organization screen is being displayed (pressing the right button 32c while the cursor 96 is aligned on the first sub character setting box 92a to the second special skill setting box 94b) (YES in S100-1), the character setting unit 104a temporarily stores the selected icon (S100-2). Furthermore, when an operation of determining the sub character candidate is input while one of the boxes is temporarily selected (pressing the right button 32c while the cursor 96 is aligned on the retain icon 90) (YES in S100-3), the character setting unit 104a stores the selected sub character candidate in the temporarily selected box (S100-4).

Furthermore, when an automatic setting operation (pressing the right button 32c while the cursor 96 is aligned on the automatic organization button 98) is input (YES in S100-5), the automatic organization processing unit 106a executes the automatic organization process (S200). The automatic organization process is described below.

In addition, when an evolution operation of raising the evolution level of a sub character candidate is input by using an item (YES in S100-6), the character setting unit 104a updates the evolution level of the selected sub character candidate (S100-7). Note that the information on the retained sub character candidates and the evolution levels of the sub character candidates are reset each time one in-game ends. Alternatively, the information on the retained sub character candidates and the evolution levels thereof may be carried over to the out-game or a next in-game.

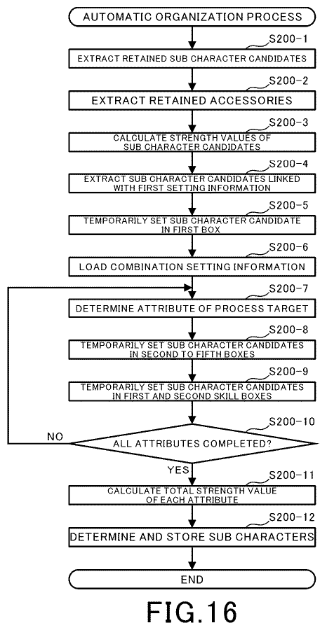

FIG. 16 is a flowchart indicating an automatic organization process. The automatic organization processing unit 106a first extracts the retained sub character candidates (S200-1). Furthermore, the automatic organization processing unit 106a extracts retained accessories (S200-2). Note that the player can acquire and retain accessories as rewards during the game. The accessories bring effects of changing various parameters, and when the player retains an accessory, a particular parameter changes. For example, accessories are set to have attributes as with the sub characters 70. There are accessories that raise the strength values of the sub characters 70 that have the same attribute as the retained accessories.

Next, the automatic organization processing unit 106a calculates the strength value of all sub character candidates extracted in S200-1 (S200-3). Here, the strength value is calculated by taking into account the accessories that the player retains. Alternatively, the strength value may be calculated without taking into account the effects of the accessories, and then the effects brought about by the accessories may be added.

Next, the automatic organization processing unit 106a extracts, from among the sub character candidates extracted in S200-1, those sub character candidates that are linked with the first setting information (S200-4). Next, the automatic organization processing unit 106a classifies the sub character candidates extracted in S200-4 by the attribute, and, for each attribute, temporarily sets the sub character candidate having the highest strength value in the first sub character setting box 92a (S200-5).

Next, the automatic organization processing unit 106a loads the combination setting information (S200-6). Then the automatic organization processing unit 106a determines the attribute of the process target (S200-7), and temporarily sets sub character candidates in the second to fifth sub character setting boxes 92b to 92e on the basis of the combination setting information (S200-8). Next, the automatic organization processing unit 106a temporarily sets sub character candidates in the first special skill setting box 94a and the second special skill setting box 94b (S200-9).

The processes S200-7 to S200-9 are executed for all attributes, and upon completion of the processes for all attributes (YES in S200-10), the automatic organization processing unit 106a calculates the total strength value of each attribute (S200-11). Furthermore, the automatic organization processing unit 106a determines and stores the sub character candidate of the attribute with the highest total strength value as the sub character 70 or the special skill (S200-12).

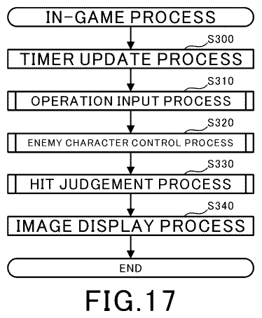

FIG. 17 is a flowchart indicating an in-game process. During the in-game, the in-game processing unit 102a repeats the in-game process illustrated in FIG. 17 at frame update intervals. A frame, that is, the game screen, is updated 30 times in a second, for example. In such a case, the frame update intervals are about 33 ms. Note that when an operation of displaying an organization screen is input during the in-game, the organization screen appears, and the preparation process illustrated in FIG. 15 is executed. In such a case, the in-game process illustrated in FIG. 17 is interrupted. Furthermore, when an operation of ending the preparation process is input after the preparation process is executed during the in-game, the preparation process ends, and the in-game process resumes.

The in-game processing unit 102a executes a timer update process (S300), an operation input process (S310), an enemy character control process (S320), a hit judgement process (S330), and an image display process (S340) during the in-game process.

In the timer update process (S300), timer values of various timers are updated. Here, a process of decrementing the timer value is executed on the timers that have a timer value larger than 0. Then the in-game processing unit 102a executes the operation input process (S310), the enemy character control process (S320), and the hit judgement process (S330), and then, on the basis of the results of these processes, executes the image display process (S340) of updating the game screen.

In the image display process (S340), the boss character 50, the main character 60, and sub characters 70 are displayed in the game screen on the basis of the position information of the boss character 50 and the main character 60. Here, the sub characters 70 are displayed in the display appearances corresponding to the evolution levels. In addition, on the basis of the game information and various parameters, the boss character HP bar 52, the main character HP bar 62, the main character icon 64, the fever gauge 66, the sub character icons 72, the special skill icons 74, and the skill gauges 76 are displayed. The operation input process (S310), the enemy character control process (S320), and the hit judgement process (S330) will now be described in detail.

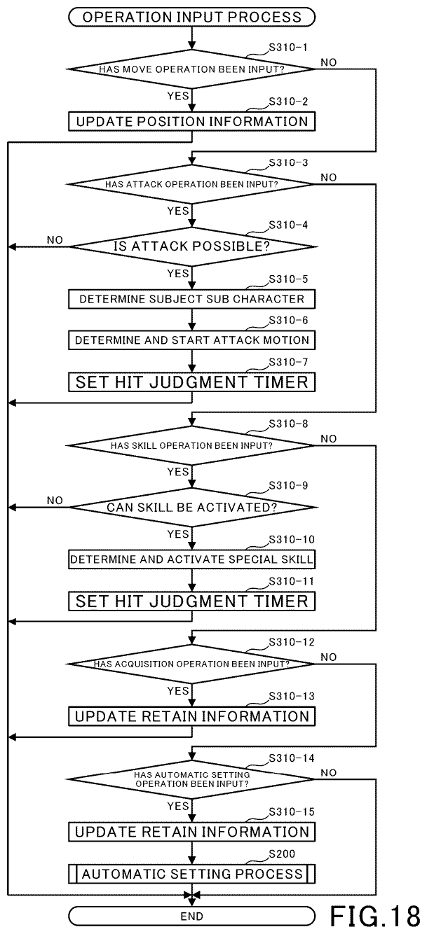

FIG. 18 is a flowchart indicating the operation input process. The in-game processing unit 102a updates the position information of the main character 60 (S310-2) when a move operation (for example, a tilt operation of the tilt operation unit 34) that moves the main character 60 is input (YES in S310-1). In addition, when an attack operation (for example, an operation of pressing the left button 32a) is input (YES in S310-3), the in-game processing unit 102a judges whether there is a state in which an attack is possible (S310-4). Examples of the state in which the attack is possible include being outside the aforementioned invalid period, being outside the standby period set after the end of the attack motion of the sub character 70, and being within the aforementioned combination accepting period.

If there is a state in which an attack is possible (YES in S310-4), the sub character 70 to carry out the attack motion, that is, a subject sub character 70, is determined (S310-5). Note that when an attack motion is executed, a counter value of an attack target identifying counter is updated. For example, when the counter value of the attack target identifying counter is 1 to 4, 1 is added to the current counter value. Furthermore, when the counter value of the attack target identifying counter is 5, the value is updated to 1. The sub character 70 that carries out the attack motion is determined on the basis of the counter value of the attack target identifying counter.

For example, when the counter value of the attack target identifying counter is 1, it is determined that the first sub character 70a is to carry out the attack motion, and when the counter value of the attack target identifying counter is 5, it is determined that the fifth sub character 70e is to carry out the attack motion. When the attack operation is not input during the combination accepting period, the counter value of the attack target identifying counter is updated to 1 as the combination accepting period ends. As a result, when an attack operation is input in the next state in which an attack is possible, the first sub character 70a carries out the attack motion.

The in-game processing unit 102a determines the attack motion linked with the sub character 70 determined in S310-5 (S310-6). In addition, a process for starting the determined attack motion is executed here. For example, when the fifth sub character 70e has carried out the attack motion, the time of the standby period set upon completion of the attack motion is set in a particular timer. Here, the timer value set in the timer, that is, the time of the standby period, is decremented by the aforementioned timer update process (S300). When the timer value is larger than 0, it is judged to be within the attack motion standby period, and, for example, the attack cannot be made. Alternatively, the process related to the attack motion may differ depending on whether or not there is a combination valid state.

Next, the in-game processing unit 102a sets the timer value in the hit judgement timer (S310-7). The hit judgement timer is a timer that counts the standby time from the start of the attack motion until the hit judgement process described below is executed. As mentioned above, hit judgement information is set for each attack motion. The hit judgement information includes a standby time until the hit judgement process is executed. Here, the standby time set for the attack motion determined in S310-6 is set in the hit judgement timer.

In addition, when an operation for activating a special skill (for example, an operation of pressing the up button 32b or the right button 32c) is input (YES in S310-8), the in-game processing unit 102a judges whether or not there is a state in which the skill can be activated (S310-9).

If there is a state in which the skill can be activated (YES in S310-9), the in-game processing unit 102a determines what special skill to be activated on the basis of the sub character candidate set in the first special skill setting box 94a or the second special skill setting box 94b, and the operation that has been input (S310-10). In addition, a process for activating the determined special skill is executed here.

Next, the in-game processing unit 102a sets the timer value in the hit judgement timer (S310-11). Here, the standby time set for each special skill is set in the hit judgement timer.

When an acquisition operation (for example, an operation of pressing the side button 36) for acquiring a reward is input (YES in S310-12), the in-game processing unit 102a acquires a reward and updates the information regarding the items and sub character candidates retained as rewards (S310-13).

When an automatic setting operation (for example, an operation of long-pressing the side button 36) is input during the in-game (YES in S310-14), the in-game processing unit 102a acquires a reward and updates the information regarding the sub character candidates retained as rewards (S310-15). Then the automatic organization processing unit 106a executes the aforementioned automatic organization process illustrated in FIG. 16 (S200).

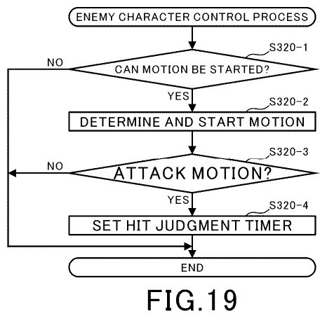

FIG. 19 is a flowchart indicating the enemy character control process. The in-game processing unit 102a determines a motion to be carried out when the boss character 50 is capable of starting a new motion (YES in S320-1) (S320-2). In addition, a process for starting the determined motion is executed here. Note that the motion of the boss character 50 includes an attack motion, a move motion, etc. Furthermore, the attack motion may include a normal attack motion and a special attack motion that inflicts larger damage than the normal attack motion.

When an attack motion is determined (YES in S320-3), the in-game processing unit 102a sets the hit judgement timer for the boss character 50 (S320-4). In other words, the attack motion of the boss character 50 is also linked with a standby time until the hit judgement process is executed.

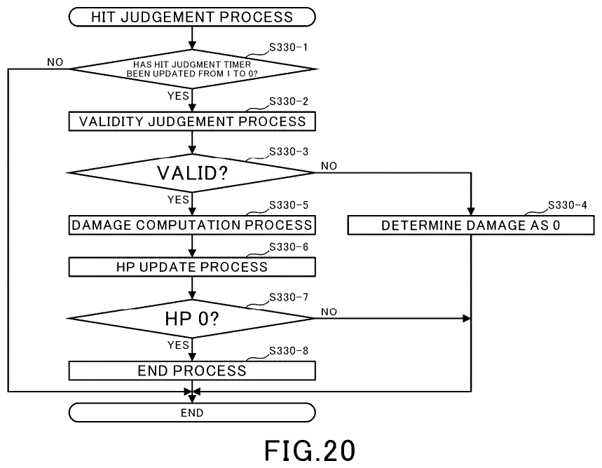

FIG. 20 is a flowchart indicating the hit judgement process. In S300, the in-game processing unit 102a judges whether the hit judgement timers for the sub characters 70 and the hit judgement timer for the boss character 50 are updated from 1 to 0 (S330-1). When the hit judgement timers are updated from 1 to 0 (YES in S330-1), the in-game processing unit 102a executes a validity judgement process (S330-2).

Here, in the validity judgement process of the attack motions of the sub characters 70, it is judged whether or not the boss character 50 is located within an attack range. Similarly, in the validity judgement process of the attack motion of the boss character 50, it is judged whether or not the main character 60 is located within an attack range. Furthermore, in the validity judgement process of the attack motion of the boss character 50, it is judged whether or not the fever mode is running. As described above, during the fever mode, the main character 60 transforms into a special character. In this state, irrespective of the position of the special character, the attack motion of the boss character 50 is judged invalid.

When the attack motion of the sub character 70 or the boss character 50 is judged invalid (NO in S330-3), the in-game processing unit 102a determines the damage to be 0 (S330-4). In contrast, when the attack motion of the sub character 70 or the boss character 50 is judged valid (YES in S330-3), the in-game processing unit 102a executes a damage computation process (S330-5). Here, the damage value is calculated on the basis of the parameters etc., set for the attack motion.

The in-game processing unit 102a executes a HP update process of subtracting the damage value calculated in S330-5 from the HP of the opponent (S330-6). When the HP after update is 0 (YES in S330-7), the in-game processing unit 102a executes an end process (S330-8). In this end process, a process for ending the in-game when the HP of the main character 60 has reached 0 is executed. In contrast, when the HP of the boss character 50 has reached 0, a process for ending the current boss stage is executed.

Although an aspect of the embodiments is described above with reference to the attached drawings, it is needless to say that the present invention is not limited to the aforementioned embodiments. Obviously, any person skilled in the art could easily conceive of various modification examples and altered examples without departing from the scope defined by the claims, and such examples are understood as naturally within the technical scope.

The game elements and the processes in the player terminal 1 described in the embodiments above are merely examples. For example, some of the aforementioned processes may be executed in the server 1000 instead of the player terminal 1. In any case, the information processing program may be any program that instructs a computer (in the embodiments, one or both of the player terminal 1 and the server 1000) to execute the following processes.

### Processes to be Executed by Computer

A process (in the embodiments, the examples are S100-4 and S200) of setting multiple sub objects (in the embodiments, one example thereof is sub characters 70) displayed in the game screen along with a main object (in the embodiments, one example thereof is a main character 60) on the basis of the setting operation of the player.

A process (in the embodiments, the examples are S310-5 and S310-6) of carrying out, in a preset order, attack motions individually specified for the multiple sub objects displayed in the game screen on the basis of the attack operation of the player.

A process (in the embodiments, one example is S100-7) of updating display information (in the embodiments, one example is the evolution level) corresponding to the display appearance of a sub object upon satisfying a particular condition (in the embodiments, one example is an input of an evolution operation).

A process (in the embodiments, one example is S340) of displaying, in the game screen, the sub objects in the display appearances based on the display information.

In the aforementioned embodiments, the case in which sub characters 70 are provided as one example of the sub objects is described. However, the sub objects are not limited to the sub characters 70. For example, sub objects may be weapons and skills that the main character 60 has, and motions may be linked with the weapons and skills. In such a case, the motions specified for the weapons and skills may be activated in a particular order upon input of the attack operation. Note that in such a case also, the weapons and skills that serve as sub objects may be displayed separately or integrally with the main character 60 (main object).

The process of carrying out the attack motion may involve carrying out attack motions in a preset order when one attack operation is input and then a next attack operation is input within a particular time. In the aforementioned embodiments, an invalid period and a combination accepting period are set for the attack motion. However, the invalid period is not essential, and only the combination accepting period may be provided.

In the aforementioned embodiments, the boss character carries out the attack motion; however, the boss character does not have to carry out an attack motion. For example, the stage may be cleared by reducing the HP of the boss character to 0 before a time limit without having the boss character to carry out the attack motion. In any case, the game elements of the aforementioned embodiments are merely examples, and design alterations and modifications are possible as appropriate.

In the aforementioned embodiments, the hit judgement information is specified for every attack motion. Alternatively, the hit judgement information may be specified for every sub character candidate.

In the aforementioned embodiments, the automatic organization function of automatically selecting and setting multiple sub characters 70 on the basis of the player's inputs of the automatic setting operations is provided. However, the automatic organization function is not essential. Furthermore, the automatic organization function algorithm in the embodiments described above is merely an example. In any case, when an automatic organization function is provided, the process of setting sub objects may involve selecting and setting multiple sub objects according to a particular algorithm on the basis of the input of the automatic setting operation.

Note that the information processing program for executing the processes of the aforementioned embodiments and various modification examples may be stored in a computer-readable non-transitory storage medium and provided as a storage medium. Furthermore, a game terminal device that includes this storage medium may be provided. The aforementioned embodiments and various modification examples may be configured as an information processing method that realizes the functions and the steps shown in the flowcharts.

What is claimed is:

1. A non-transitory computer readable medium storing a program instructing a computer to execute:
a process of setting, on a basis of a setting operation of a player, a plurality of sub objects to be displayed in a game screen along with a main object;
a process of carrying out, on a basis of an attack operation of the player, attack motions respectively specified for the plurality of sub objects displayed in the game screen, the attack motions being carried out in a preset order;
a process of updating display information corresponding to display appearances of the sub objects when a particular condition is satisfied; and
a process of displaying, in the game screen, the sub objects in the display appearances based on the display information.

2. The non-transitory computer readable medium according to claim 1,
wherein the process of carrying out the attack motions involves
carrying out the attack motions in the preset order when, after one of the attack operation is input, the next attack operation is input within a particular time.

3. The non-transitory computer readable medium according to

1.,
wherein the setting operation includes an automatic setting operation, and
the process of setting the sub objects involves
selecting and setting the sub objects according to a particular algorithm on the basis of an input of the automatic setting operation.

4. An information processing method to be executed by at least one computer,
wherein the at least one computer executes:
a process of setting, on a basis of a setting operation of a player, a plurality of sub objects to be displayed in a game screen along with a main object;
a process of carrying out, on a basis of an attack operation of the player, attack motions respectively specified for the plurality of sub objects displayed in the game screen, the attack motions being carried out in a preset order;
a process of updating display information corresponding to display appearances of the sub objects when a particular condition is satisfied; and
a process of displaying, in the game screen, the sub objects in the display appearances based on the display information.

5. An information processing system comprising at least one computer,
wherein the at least one computer executes:
a process of setting, on a basis of a setting operation of a player, a plurality of sub objects to be displayed in a game screen along with a main object;
a process of carrying out, on a basis of an attack operation of the player, attack motions respectively specified for the plurality of sub objects displayed in the game screen, the attack motions being carried out in a preset order;
a process of updating display information corresponding to display appearances of the sub objects when a particular condition is satisfied; and
a process of displaying, in the game screen, the sub objects in the display appearances based on the display information.
